(19) United States
(12) Patent Application Publication
(10) Pub. No.: US 2015/0110439 A1
(43) Pub. Date: Apr. 23, 2015

(54) DISTRIBUTED FIBER OPTIC SENSING DEVICES FOR MONITORING THE HEALTH OF AN ELECTRICAL SUBMERSIBLE PUMP

(71) Applicant: HALLIBURTON ENERGY SERVICES, INC., Houston, TX (US)

(72) Inventors: Michael L. FRIPP, Carrollton, TX (US); Jason D. DYKSTRA, Houston, TX (US); Fanping BU, Houston, TX (US)

(73) Assignee: Halliburton Energy Services, Inc.

(21) Appl. No.: 14/471,395

(22) Filed: Aug. 28, 2014

Related U.S. Application Data
(63) Continuation of application No. PCT/US13/65489, filed on Oct. 17, 2013.

(51) Int. Cl. G01D 5/26

(52) U.S. Cl. CPC G01D 5/268
USPC 385/12

(57) ABSTRACT

A method of determining a parameter of at least one component of an artificial lift system located in a subterranean formation comprises: introducing a distributed fiber optic sensing device into the subterranean formation, wherein the distributed fiber optic sensing device comprises: a fiber optic cable, wherein at least a portion of the fiber optic cable is positioned proximate to the at least one component of the artificial lift system; an optical signal source, wherein the optical signal source transmits an optical signal through the fiber optic cable; and a detector, wherein the detector measures the optical signal returned from the fiber optic cable; and a processor, wherein the processor is operatively connected to the detector; and determining the parameter of the at least one component of the artificial lift system via the processor.

### TECHNICAL FIELD

Electrical submersible pumps (ESPs) are used in artificial lift operations to pump oil or gas to a wellhead. Distributed acoustic fiber optic sensing devices and distributed temperature fiber optic sensing devices can be used to monitor and diagnose the health and operation of one or more components of an ESP.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIG. 1 is a schematic illustration of a well system containing an electrical submersible pump and distributed fiber optic sensing device according to an embodiment.

### DETAILED DESCRIPTION

As used herein, the words “comprise,” “have,” “include,” and all grammatical variations thereof are each intended to have an open, non-limiting meaning that does not exclude additional elements or steps.

As used herein, a “fluid” is a substance having a continuous phase that tends to flow and to conform to the outline of its container when the substance is tested at a temperature of 71° F. (22° C.) and a pressure of one atmosphere “atm” (0.1 megapascals “MPa”). A fluid can be a liquid or gas.

Oil and gas hydrocarbons are naturally occurring in some subterranean formations. In the oil and gas industry, a subterranean formation containing oil, gas, or water is referred to as a reservoir. A reservoir may be located directly beneath land or offshore areas. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

A well can include, without limitation, an oil, gas, or water production well. As used herein, a “well” includes at least one wellbore. The wellbore is drilled into a subterranean formation. The subterranean formation can be a part of a reservoir or adjacent to a reservoir. A wellbore can include vertical, inclined, and horizontal portions, and it can be straight, curved, or branched. As used herein, the term “wellbore” includes any cased, and any uncased, open-hole portion of the wellbore.

After a well has been drilled and completed, the reservoir fluid is produced from the subterranean formation and into a production tubing string. The produced fluid flows through the production tubing string towards the wellhead. During production, a variety of artificial lift devices can be used to move the fluid towards the wellhead. One such device is an electrical submersible pump (“ESP”). An ESP generally includes a motor for operating the pump, a pump intake, and an optional gas-liquid separator. The pump literally pushes the fluid upwards towards the wellhead via an intake of fluid surrounding the ESP through the pump intake. The motor of the ESP receives power from an electrical umbilical. Once an ESP is placed into a wellbore, it is extremely difficult to monitor the health or operation of the components of the ESP or the umbilical. Generally, an operator's only way of knowing if an ESP is experiencing mechanical difficulties is when the amount of fluid reaching the wellhead diminishes or stops. When an ESP experiences mechanical difficulties, the ESP must be pulled out of the wellbore and the malfunctioning component repaired or replaced. It can also be difficult to ensure that the pump intake is surrounded by a liquid. If a liquid does not cover the top of the intake, then mechanical problems can occur to components of the pump. It is also difficult to predict the impending failure of an ESP, which is important in order to schedule the repair or replacement of components.

Accordingly, there is a need for being able to monitor the health and operation of an ESP, its components, and the electrical umbilical. There is also a need for being able to determine the location of a liquid/gas line within a wellbore. It has been discovered that a distributed acoustic sensing (DAS) or distributed temperature sensing (DTS) fiber optic device can be used to accomplish both of these objectives. Unlike other systems that utilize separate sensors to collect information and then relay the information to workers via a fiber optic cable, the current system uses the fiber optic cable as the DAS or DTS sensors.

In a DAS and a DTS system, a fiber optic cable is used to provide distributed measurements. An optical signal source, such as a laser, emits pulses of light that are then transmitted through the fiber optic cable. Because the cable includes optically-conducting fibers containing a plurality of backscattering inhomogeneities along the length of the fiber, such systems allow the distributed measurement of axial strain along the optical fiber by measuring the disturbances in the scattered light from the laser pulse input into the fiber. Because the fibers allow distributed sensing, such systems may be referred to as DAS or DTS systems depending on the nature of the backscattering and the nature of the measurement. The disturbances in the scattered light can be a result of mechanical strain or of temperature in the optical fibers. The light is then returned from the fiber optic cable to a detector that is able to measure the intensity of the optical signal that was returned from the cable as a function of time after transmission of the pulse of light. A processor can then be used to determine a specific parameter of interest using the measurements from the detector. Generally, because the detector measures intensity as a function of time, the optical signal source is commonly pulsed at a selected frequency that allows all of the light to be returned from one pulse before emitting the next pulse of light. The time it takes for the reflected light to return can be used to determine the depth or length of the fiber from which the light is being returned. Moreover, changes in the frequency and/or amplitude from a particular location along the cable can be indicative of changes to one or more components of the artificial lift system or, more specifically, of an electrical submersible pump (“ESP”). Therefore, the system can be used to monitor and determine a parameter of at least one component of an ESP.

According to an embodiment, a method of determining a parameter of at least one component of an electrical submersible pump located in a subterranean formation comprises: introducing a distributed fiber optic sensing device into the subterranean formation, wherein the distributed fiber optic sensing device comprises: a fiber optic cable, wherein at least a portion of the fiber optic cable is positioned around the perimeter of, or adjacent to, the at least one component of the electrical submersible pump; an optical signal source, wherein the optical signal source transmits an optical signal through the fiber optic cable; and a detector, wherein the detector measures the optical signal returned from the fiber optic cable; and a processor, wherein the processor is operatively connected to the detector; and determining the parameter of the at least one component of the electrical submersible pump via the processor.

Any discussion of the embodiments regarding the system or any component related to the system (e.g., a distributed fiber optic sensing device) is intended to apply to all of the method and system embodiments. Any discussion of a particular component of an embodiment (e.g., a fiber optic cable) is meant to include the singular form of the component and the plural form of the component, without the need to continually refer to the component in both the singular and plural form throughout. For example, if a discussion involves “the fiber optic cable,” it is to be understood that the discussion pertains to a fiber optic cable (singular) and two or more fiber optic cables (plural). Without loss of generality, it is to be understood that the fiber optic cable can be a single mode fiber optic cable or a multimode fiber optic cable.

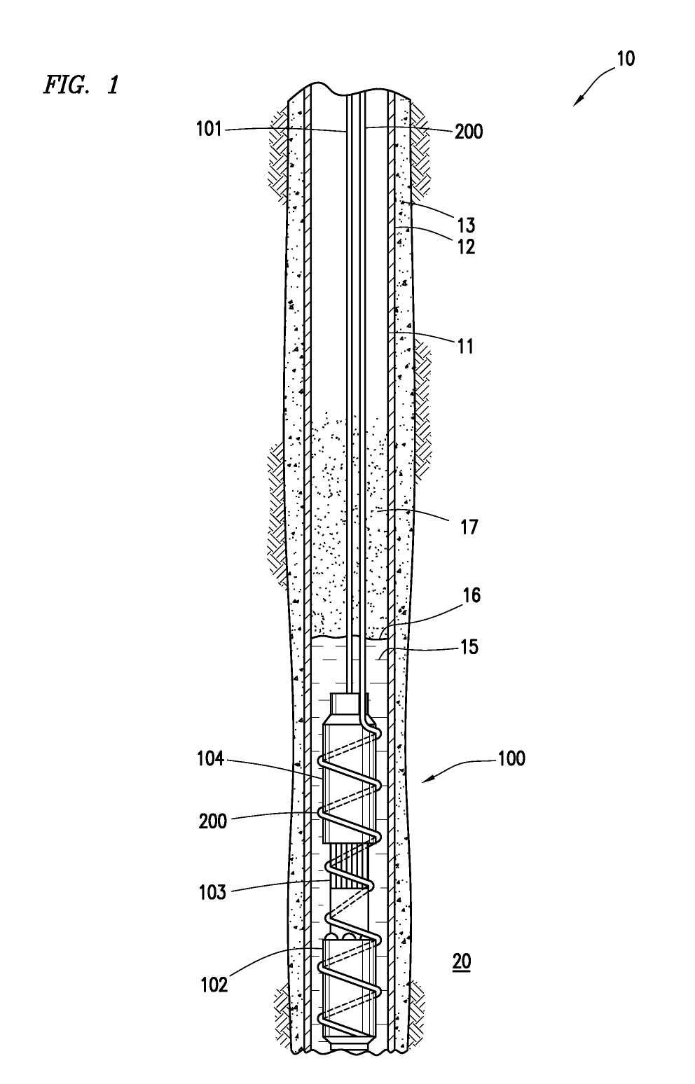

Turning to the Figures, FIG. 1 is a schematic illustration of a well system 10. The methods include introducing a distributed fiber optic sensing device into a subterranean formation 20. The well system 10 can include at least one wellbore 11. The wellbore 11 can penetrate the subterranean formation 20. The methods can also include introducing the distributed fiber optic sensing device into the wellbore 11. The subterranean formation 20 can be a portion of a reservoir or adjacent to a reservoir. The wellbore 11 can include an open-hole wellbore portion and/or a cased-hole wellbore portion. The wellbore 11 can include a casing 12. The casing 12 can be cemented in the wellbore 11 via cement 13. The casing 12 can include perforations that allow reservoir fluids from the subterranean formation to enter the interior of the casing 12. The wellbore 11 can include only a generally vertical wellbore section or can include only a generally horizontal wellbore section. A tubing string (not shown) can be installed in the wellbore 11. According to an embodiment, the tubing string is a production tubing string. The wellbore can be a producing wellbore. The producing wellbore can produce a variety of reservoir fluids including, but not limited to, liquid hydrocarbons, gas hydrocarbons, non-hydrocarbons for example water, and any combinations thereof in any proportion.

The well system 10 includes an artificial lift system which is noted as an electrical submersible pump (“ESP”) 100. The well system 10 can also include more than one or a plurality of ESPs. The fiber optic cable can be positioned around the perimeter of, or adjacent to, at least one component of the more than one or plurality of ESPs. The ESPs can be stacked on top of one another to make up a pump stage or multistage pump. It is to be understood that any discussion regarding the ESP includes all ESPs that are located in the wellbore regardless of the exact total number of ESPs used. The ESP 100 can be part of an artificial lift operation. Artificial lift is commonly used when reservoir fluids no longer flow up to the wellhead due to natural reservoir pressures, and the well is no longer producing on its own. During artificial lift, an ESP can be used to pump the reservoir fluid to the wellhead. The ESP 100 can be installed within the wellbore 11 on a tubing string, such as a production tubing string (not shown).

The ESP 100 can include a variety of components. The ESP 100 can include a motor 102. Electric power can be supplied to the motor 102 via an umbilical 101. The umbilical 101 can be located on the outside or inside of a tubing string (not shown). The umbilical 101 can be any type of cable that supplies the necessary power to the motor, for example, the umbilical can be a heavy-duty armored cable. The ESP 100 can also include a pump 104. Under normal operation, when the motor 102 is supplied with electric power, the pump 104 can move the reservoir fluid towards the wellhead. By way of example, the pump 104 can contain one or more impellers (not shown) that moves the reservoir fluid towards the wellhead when the impellers spin. The ESP 100 can also include a pump intake 103. The pump intake 103 can be located between the motor 102 and the pump 104. The pump intake 103 can draw reservoir fluids into the pump 104 to be moved towards the wellhead via the pump. The ESP 100 can further include a separator (not shown) that can be positioned between the motor 102 and the pump intake 103. The separator can seal reservoir fluids from entering the motor and can also help buffer the pump from movement by the motor. At least the motor 102, the pump intake 103, and the pump 104 can be surrounded by wellbore liquids.

It should be noted the well system that is illustrated in the drawings and described herein is merely one example of a wide variety of well systems in which the principles of this disclosure can be utilized. It should be clearly understood that the principles of this disclosure are not limited to any of the details of the well system, or components thereof, depicted in the drawings or described herein. Furthermore, the well system can include other wellbore components not depicted in the drawing. By way of example, the wellbore can include one or more wellbore intervals that correspond to one or more subterranean formation zones. Packers and/or cement can be used to create the wellbore intervals. The reservoir fluid can be produced from the one or more subterranean formation zones.

The distributed fiber optic sensing device includes a fiber optic cable 200. The fiber optic cable 200 can be located on the outside, inside, or combinations thereof of a tubing string (not shown). The fiber optic cable 200 can also be attached to the umbilical 101 such that the cable and umbilical are introduced into the subterranean formation 20 or wellbore 11 together. The fiber optic cable 200 can include a plurality of optical fibers. Each optical fiber can be coated, for example, with a plastic. The optical fibers can be bundled together to form the fiber optic cable 200. The bundle of optical fibers can be contained within a sheath, such as a tube. The sheath can protect the fibers from the environment of the wellbore, for example.

The fiber optic cable 200 is positioned around the perimeter of, or adjacent to, the at least one component of the ESP 100. The at least one component can be, without limitation, the motor 102, the pump 104, the pump intake 103, or the umbilical 101. According to an embodiment, the fiber optic cable 200 is positioned around the perimeter of, or adjacent to, all of the components of the ESP 100. By way of example, the fiber optic cable 200 can span from an area above the wellhead all the way down the umbilical 101 to the bottom of the ESP 100. The fiber optic cable 200 can be positioned around the perimeter of the ESP 100 and can be positioned adjacent to the umbilical 101. The fiber optic cable 200 can also be positioned around the perimeter of both the ESP 100 and the umbilical 101 or the cable can be positioned adjacent to both the ESP and umbilical. There can also be more than one fiber optic cable that is introduced into the subterranean formation—one that is positioned around or adjacent to the ESP and another one that is positioned adjacent to the umbilical. The fiber optic cable 200 can be attached to the component(s) of the ESP 100 via a variety of mechanisms including, but not limited to, clips, clamps, adhesives, or friction locks. The fiber optic cable 200 can also be attached to a wellbore component that is located adjacent to the component(s) of the ESP 100. For example, the fiber optic cable 200 can be connected to a tubing string, which is adjacent to the umbilical 101. The fiber optic cable 200 can be positioned around the ESP 100 in a variety of patterns. As depicted in FIG. 1, the fiber optic cable 200 can be positioned around the ESP 100 in a generally helical pattern. The fiber optic cable 200 can also be looped down, back up, and back down, and so on, around the perimeter of the ESP 100 in an S-curve type fashion. The exact configuration of the fiber optic cable 200 around the perimeter of, or adjacent to, the component(s) can be configured to better pinpoint the location of a sound or temperature, and to achieve a desired spatial resolution of the returned optical signal, among other things.

The fiber optic cable 200 can be a variety of lengths. Preferably, the length of the fiber optic cable 200 is selected such that a portion of the cable is positioned around the perimeter of, or adjacent to, the at least one component of the ESP 100, more preferably, all of the components of the ESP, and most preferably, all of the components of two or more ESPs.

The distributed fiber optic sensing device includes an optical signal source (not shown), wherein the optical signal source transmits an optical signal through the fiber optic cable 200. The optical signal can be light. The optical signal source can be a monochromatic laser, lasing or non-lasing light emitting diode (LED), a white light, or other suitable source. The optical signal can travel through the fiber optic cable 200, wherein at least some of the optical signal is reflected or backscattered. The scattering can be Raleigh, Brillouin, or Raman backscattering. The optical signal source can emit pulses of light. Preferably, the time between the pulses is selected such that all of the optical signal is reflected and returned to a detector before the next pulse is transmitted.

The distributed fiber optic sensing device includes the detector. The detector, such as a photodiode or other photo-detector measures the optical signal returned from the fiber optic cable 200. The distributed fiber optic sensing device can be a distributed acoustic sensing (“DAS”) fiber optic device. For a DAS fiber optic device, one or more components of the electrical submersible pump (“ESP”) 100 can generate sounds. For example, the motor 102, the pump intake 103, and the pump 104 can all generate sound waves. The wavelength, frequency, frequency harmonics, and amplitude of the sound waves can be the same or different for the different components. Moreover, the wavelength, frequency, and amplitude can change during operation of the ESP. By way of example, when bearings or parts of the motor begin to fail or experience mechanical problems, there can be an observed grinding sound. The grinding sound will have a different wavelength or frequency compared to the wavelength or frequency during normal operation. By way of another example, electrical arcing in a portion of the umbilical can generate a sound. Each unique sound wave can create a unique reflection of the optical signal that is returned to the detector. The detector can also measure the length of time it takes for the optical signal to be returned. In this manner, the detector can measure the reflected signal and the time for return to pinpoint the location and cause of the problem.

The DAS fiber optic device can also be used to determine the location of a liquid-gas line 16 in the wellbore 11. The liquid-gas line 16 is located at the interface between a liquid 15, for example a reservoir fluid, and a gas 17. The acoustic reflection will be different at the liquid-gas line 16, which can cause a discontinuity of the acoustic signature at the fluid level. Moreover, the speed of sound, the attenuation, and the fluid coupling is different in liquids versus gases. Therefore, the time it takes for the reflected optical signal to return can be used to determine the depth or location of the liquid-gas line 16.

The distributed fiber optic sensing device can also be a distributed temperature sensing (“DTS”) fiber optic device. The temperature generated from or surrounding the at least one component of the electrical submersible pump (“ESP”) 100 can change. By way of example, bearings or parts of the motor can overheat when malfunctioning or failing; thus, causing an increase in temperature. Moreover, electrical arcing in the umbilical can create a hot spot. Therefore, the DTS fiber optic device can be used to measure changes or increases in the temperature of one or more components of the ESP via the reflected optical signal. Similar to the DAS fiber optic device, the length of time it takes for the returned signal to arrive at the detector can be used to determine exactly which component of the ESP is experiencing failure or mechanical problems because the depth of the components can be known. For the DTS fiber optic device, it may be easier to detect changes in temperature when the component is located in the portion of the wellbore containing a gas because gas is a more thermally insulating state of matter compared to a liquid.

The DTS fiber optic device can also be used to determine the liquid-gas line 16 in the wellbore 11. The thermal properties, such as heat capacity and thermal conductivity, of liquids are different from gases. As such, the thermal gradient will shift at the liquid-gas line 16. If more than two distributed fiber optic sensing devices are used, then one device can be a DAS fiber optic device and the other device can be a DTS fiber optic device.

The distributed fiber optic sensing device includes a processor, wherein the processor is operatively connected to the detector. Examples of suitable processors include, but are not limited to, a DSP processor, an ARM processor, and a PIC processor. The processor can display and/or store the measurements from the detector. The processor can also perform a command, such as causing the optical signal source to transmit the optical signal through the optical fiber cable.

The methods include determining the parameter of the at least one component of the ESP via the processor. According to an embodiment, the methods include determining a parameter of two or more components of the ESP via the processor. Preferably, the distributed fiber optic sensing device is capable of determining a parameter of all the components of the ESP. The parameter can be related to the health and/or operation of the component(s) of the ESP. The parameter can be, without limitation: mechanical problems with one or more subcomponents (e.g., bearings) of the component; overheating of the component; electrical arcing; the liquid-gas line in the wellbore; cavitation; wear; journal instabilities; etc. In this manner, during normal operation, the processor will indicate that every component is in good working order and good operational health. The distributed fiber optic sensing device can monitor the ESP components, and detect and display problems via changes in the sound or temperature that occur due to mechanical problems or failures.

The methods can further include introducing the electrical submersible pump (“ESP”) 100 into the subterranean formation 20 and optionally, the wellbore 11. The methods can also include adjusting one or more operations depending on the determination of the parameter. By way of example, if the liquid-gas line 16 is determined to be too low, then the pump rate can be decreased such that the flow rate of fluid exiting the wellbore is decreased. This will allow more fluid to remain in the wellbore and prevent damage to the pump 104 and/or pump intake 103 due to insufficient liquid levels. Conversely, it is often desirable to produce the reservoir fluid at the highest possible flow rate. Therefore, if the liquid-gas line 16 is determined to be too high, then the pump rate and flow rate can be increased. By way of another example, if it is determined that a bearing or a part of the motor is failing, then the ESP can be stopped, the ESP can be removed from the wellbore and the part can be repaired or replaced. The methods can also include removing the umbilical and/or ESP from the subterranean formation. In this manner, problems can be identified and repairs can be made prior to more serious problems occurring. More serious problems could occur if the ESP continues to try and pump a fluid when a part and/or an entire component needs to be repaired or replaced. The methods can also include repairing or replacing one or more components or subcomponents of the ESP. The methods can also include introducing a different ESP into the subterranean formation. The distributed fiber optic sensing device described herein can be used to monitor and diagnose problems of the components of an ESP.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While apparatus (such as the packer assembly) and methods are described in terms of “comprising,” “containing,” or “including” various components or steps, the compositions and methods also can “consist essentially of” or “consist of” the various components and steps. In particular, every range of values (of the form, “from about a to about b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of determining a parameter of at least one component of an artificial lift system located in a subterranean formation comprising:
introducing a distributed fiber optic sensing device into the subterranean formation, wherein the distributed fiber optic sensing device comprises:
a fiber optic cable, wherein at least a portion of the fiber optic cable is positioned proximate to the at least one component of the artificial lift system;
an optical signal source, wherein the optical signal source transmits an optical signal through the fiber optic cable; and
a detector, wherein the detector measures the optical signal returned from the fiber optic cable; and
a processor, wherein the processor is operatively connected to the detector; and
determining the parameter of the at least one component of the artificial lift system via the processor.

2. The method according to claim 1, wherein the artificial lift system comprises an electrical submersible pump.

3. The method according to claim 2, wherein the subterranean formation is penetrated by a wellbore, and wherein the electrical submersible pump pumps a reservoir fluid from the subterranean formation towards a wellhead of the wellbore.

4. The method according to claim 2, wherein the electrical submersible pump comprises a motor, a pump, a pump intake, and an umbilical.

5. The method according to claim 4, wherein electric power is supplied to the motor via the umbilical.

6. The method according to claim 4, wherein the at least one component is the motor, the pump, the pump intake, or the umbilical.

7. The method according to claim 6, wherein the configuration of the fiber optic cable proximate to the components of the electrical submersible pump is configured to achieve a desired spatial resolution of the returned optical signal.

8. The method according to claim 7, wherein the fiber optic cable is positioned around the perimeter of the electrical submersible pump in a generally helical pattern.

9. The method according to claim 1, wherein more than one fiber optic cable is introduced into the subterranean formation.

10. The method according to claim 1, wherein the optical signal is light.

11. The method according to claim 10, wherein the optical signal source emits pulses of light.

12. The method according to claim 1, wherein the distributed fiber optic sensing device is a distributed acoustic sensing fiber optic device.

13. The method according to claim 1, wherein the distributed fiber optic sensing device is a distributed temperature sensing fiber optic device.

14. The method according to claim 1, further comprising determining a parameter of two or more components of the artificial lift system via the processor.

15. The method according to claim 1, wherein the parameter is related to the operation of the at least one component of the artificial lift system.

16. The method according to claim 15, wherein the parameter is: mechanical problems with one or more subcomponents of the component; overheating of the component; electrical arcing; the liquid-gas line in the wellbore; cavitation; wear; or journal instabilities.

17. The method according to claim 1, further comprising adjusting one or more operations depending on the determination of the parameter.

18. The method according to claim 1, wherein the operation that is adjusted is the pump rate of a pump of the artificial lift system.

19. A system for determining a parameter of at least one component of an artificial lift system located in a subterranean formation comprising:
a distributed fiber optic sensing device, wherein the distributed fiber optic sensing device comprises:
a fiber optic cable, wherein at least a portion of the fiber optic cable is positioned proximate to the at least one component of the artificial lift system;
an optical signal source, wherein the optical signal source transmits an optical signal through the fiber optic cable; and
a detector, wherein the detector measures the optical signal returned from the fiber optic cable; and
a processor, wherein the processor is operatively connected to the detector;
wherein the processor uses the returned optical signal to determine or help determine the parameter of the at least one component of the artificial lift system.

20. The system according to claim 19, wherein the artificial lift system comprises an electrical submersible pump.
